(19) United States
(12) Patent Application Publication
(10) Pub. No.: US 2021/0216978 A1
(43) Pub. Date: Jul. 15, 2021

(54) Sustainability and Carbon Footprint Management Systems, Devices, and Methods

(71) Applicant: Roy P. Diaz, Seattle, WA (US)

(72) Inventor: Roy P. Diaz, Seattle, WA (US)

(73) Assignee: Roy P Diaz, Seattle, WA (US)

(21) Appl. No.: 17/145,288

(22) Filed: Jan. 9, 2021

Related U.S. Application Data
(60) Provisional application No. 62/959,180, filed on Jan. 10, 2020.

(51) Int. Cl. G06Q 20/06; G06Q 20/36; G06Q 30/00; G06Q 50/06

(52) U.S. Cl. CPC G06Q 20/0655; G06Q 50/06; G06Q 30/018; G06Q 20/3672

(57) ABSTRACT

Systems, devices, and methods are described for providing, among other things, a footprint management system (e.g., a sustainability footprint management system, carbon footprint management system, ecological footprint management system, and the like) for an aggregate of individual users and a related enterprise. Also described are systems, devices, and methods or providing, among other things, a sustainability standard compliance system having a sustainability index unit including computational circuitry configured to predict a sustainability index; a sustainability dashboard unit including computational circuitry configured to generate one or more instances of the predict sustainability index on a virtual display; and a compliance unit including computational circuitry configured to generate a compliance score based in part on a the predict sustainability index.

### RELATED APPLICATIONS

This application claims the benefit of priority under 35 USC 119(e) of U.S. Provisional Patent Application No. 62/959,180 filed Jan. 10, 2020, the contents of which are incorporated herein by reference in their entirety.

### SUMMARY

In an aspect, the present disclosure is directed to, among other things, a system for an aggregate of individual users and related enterprises to manage, monitor, or implement a collective sustainability footprint, carbon footprint, ecological footprint, and the like. In an embodiment, the system includes circuitry configured to acquire one or more of user-specific sustainability information, user-specific carbon footprint information, enterprise-wide sustainability information, or enterprise-wide carbon footprint information. In an embodiment, the system includes circuitry configured to generate one or more of a user-specific sustainability status, a user-specific carbon footprint status, an enterprise-wide sustainability status, or an enterprise-wide carbon footprint status based on the acquired user-specific sustainability information, the user-specific carbon footprint information, the acquired enterprise sustainability information, or the enterprise carbon footprint information.

In an embodiment, the system includes circuitry configured to display one or more instances of an aggregate environmental sustainability indicator, an aggregate economic sustainability indicator, or an aggregate social sustainability indicator based on an aggregate of the acquired user-specific sustainability information, the user-specific carbon footprint information, the acquired enterprise sustainability information, and the enterprise carbon footprint information. In an embodiment, the system includes circuitry configured to display one or more instances of a carbon footprint mitigation recommendation and a sustainability mitigation recommendation responsive to a comparison between the user-specific sustainability information, the user-specific carbon footprint information, the enterprise-wide sustainability information or the enterprise-wide carbon footprint information; and a target user-specific sustainability, a target user-specific carbon footprint, a target enterprise wide sustainability, or a target enterprise-wide carbon footprint.

In an aspect, the present disclosure is directed to, among other things, sustainability standard compliance system. In an embodiment, the sustainability standard compliance system includes a sustainability index unit including computational circuitry configured to predict a sustainability index. In an embodiment, the sustainability standard compliance system includes a sustainability dashboard unit including computational circuitry configured to generate one or more instances of the predict sustainability index on a virtual display. In an embodiment, the sustainability standard compliance system includes a compliance unit including computational circuitry configured to generate a compliance score based in part on a the predict sustainability index.

In an aspect, the present disclosure is directed to, among other things, a system that includes a collective sustainability unit configured to acquire sustainability information from a plurality of remote devices and to generate user-specific sustainability information or user-specific carbon footprint information based in part on the acquired sustainability information or carbon footprint information. In an embodiment, the system includes a collective carbon footprint unit configured to acquire carbon footprint information from the plurality of remote devices, and to generate enterprise-wide sustainability information or enterprise-wide carbon footprint information based in part on the acquired sustainability information or carbon footprint information.

In an embodiment, the system includes a collective carbon footprint credit unit configured to quantify carbon credits associated with the acquired sustainability information or the acquired carbon footprint information. In an embodiment, the system includes a collective carbon footprint credit unit configured to manage user-specific carbon credits and enterprise-wide carbon credits associated with enterprise-wide acquired sustainability information or carbon footprint information, in an embodiment, the system includes a user interface presenting one or more instances of user-specific carbon credits or enterprise-wide carbon credits.

In an embodiment, the system includes a carbon credit unit configured to facilitating payment to a digital wallet responsive to receiving one or more inputs indicative of transaction for to buy or sell user-specific carbon credits or enterprise-wide carbon credits. In an embodiment, the system includes a carbon credit unit configured to broadcast a request to sell user-specific carbon credits. In an embodiment, the system includes a carbon credit unit configured to broadcast to one or more client devices a request to buy or sell user-specific carbon credits or enterprise-wide carbon credits.

In an aspect, the pre sent disclosure is directed to, among other things, a sustainability and carbon footprint management system. In an embodiment, the sustainability and carbon footprint management system includes circuitry configured to initiate one or more push notices representing an enterprise-wide sustainability rating and a user-specific sustainability rating responsive to receiving sustainability information from a plurality of remote devices. In an embodiment, the sustainability and carbon footprint management system includes circuitry configured to initiate one or more push notices representing an enterprise-wide carbon footprint rating and a user-specific carbon footprint rating responsive to receiving carbon footprint information from the plurality of remote devices.

In an embodiment, the sustainability and carbon footprint management system includes a sustainability unit configured to determine a sustainability score based one or more inputs indicative of a social, environmental, or economic activity; and a carbon footprint unit configured to determine a carbon footprint score based one or more inputs indicative of a greenhouse gas emissions activity.

In an aspect, the present disclosure is directed to, among other things, a system including a personal lifetime footprint unit configured to manage a user's lifetime carbon footprint information. In an embodiment the system includes an enterprise lifetime carbon footprint unit configured to manage an enterprise's lifetime carbon footprint information. In an embodiment the system includes a commute carbon footprint unit including computational circuitry configured determine a carbon footprint associated with a daily commute. In an embodiment the system includes a consumer goods carbon footprint unit including computational circuitry configured determine a carbon footprint associated with a consumer good responsive to one or more inputs associated with a specific consumer good. (scan product).

In an embodiment the system includes a recycle carbon footprint unit including computational circuitry configured determine a carbon footprint associated with the contents of an aggregate of recyclable materials. In an embodiment the system includes a carbon footprint unit operably coupled to one or more remote sensors. In an embodiment the system includes an employer footprint unit including computational circuitry configured determine a carbon footprint associated with an employer.

In an aspect, the present disclosure is directed to, among other things, a method comprising electronically acquiring one or more of user-specific sustainability information, user-specific carbon footprint information, enterprise-wide sustainability information, or enterprise-wide carbon footprint information. In an embodiment, the method includes generating one or more of a user-specific sustainability status, user-specific carbon footprint status, enterprise-wide sustainability status, or enterprise-wide carbon footprint status based on the acquired user specific sustainability information, the user-specific carbon footprint information, the acquired enterprise sustainability information, or the enterprise carbon footprint information.

In an embodiment, the method includes electronically displaying one or more instances of an aggregate environmental sustainability indicator, an aggregate economic sustainability indicator, or an aggregate social sustainability indicator based cm the acquired user-specific sustainability information, the user-specific carbon footprint information, the acquired enterprise sustainability information, or the enterprise carbon footprint information.

In an embodiment, the method includes electronically displaying one or more instances of a carbon footprint mitigation recommendation and a sustainability mitigation recommendation responsive to a comparison between the user-specific sustainability information, the user-specific carbon footprint information, the enterprise-wide sustainability information, or the enterprise-wide carbon footprint information; and a target user-specific sustainability, a target user-specific carbon footprint, a target enterprise-wide sustainability, or a target enterprise-wide carbon footprint.

In an embodiment, the method includes generating a user interface presenting a sustainability mitigation menu and receiving one or more inputs indicative of a sustainability mitigation selection, in an embodiment, the method includes generating a user interface presenting a carbon footprint mitigation menu and receiving one or more inputs indicative of a carbon footprint mitigation selection. In an embodiment, the method includes generating a user interface presenting an enterprise-sponsored sustainability mitigation menu and receiving one or more inputs indicative of an enterprise-sponsored sustainability mitigation selection.

In an embodiment, the method includes generating a user interface presenting an enterprise-sponsored carbon footprint mitigation menu and receiving one or more inputs indicative of an enterprise-sponsored carbon footprint mitigation selection. In an embodiment, the method includes generating a user interface presenting an enterprise-sponsored sustainability mitigation menu and an enterprise-sponsored carbon footprint mitigation menu and receiving one or more inputs indicative of at least one of an enterprise-sponsored sustainability mitigation selection or an enterprise-sponsored carbon footprint mitigation selection.

In an aspect, the present disclosure is directed to, among other things, a method comprising acquiring sustainability information from a plurality of remote devices. In an embodiment, the method includes acquiring carbon footprint information from the plurality of remote devices. In an embodiment, the method includes generating user-specific sustainability information or user-specific carbon footprint information based in part on the acquired sustainability information or carbon footprint information. In an embodiment, the method includes generating enterprise-wide sustainability information or enterprise-wide carbon footprint information based in part on the acquired sustainability information or carbon footprint information. In an embodiment, the method includes determining a sustainability or carbon footprint award level based in part on the acquired sustainability information or carbon footprint information. In an embodiment, the method includes deriving energy consumption information from one or more digital images associated with a utility meter output. In an embodiment, the method includes deriving energy consumption information from one or more digital images associated with waste materials. In an embodiment, the method includes deriving energy consumption information from one or more digital images associated with compost materials.

### BRIEF DESCRIPTION OF THE FIGURES

FIG. 1 is a schematic diagram of a system for managing, monitoring, implementing; or deploying a sustainability footprint; carbon footprint, ecological footprint program and the like according to an embodiment.

FIG. 2 is a schematic diagram of a sustainability and carbon footprint management system according to an embodiment.

FIG. 3 is a schematic diagram of a system according to an embodiment.

FIG. 4 is a schematic diagram of sustainability standard compliance system, a sustainability audit and certification system, and the like according to one embodiment.

FIG. 5 is a schematic diagram of a sustainability system according to an embodiment.

FIG. 6 shows a flow diagram of a method according to an embodiment.

FIG. 7 is a schematic diagram of a sustainability standard compliance system according to an embodiment.

FIG. 8 is a schematic diagram of sustainability system according to an embodiment.

FIG. 9 shows a flow diagram of a method according to an embodiment.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here.

### DETAILED DESCRIPTION

How do we meet our present needs without compromising the ability of future generations to meet their own needs? it requires a concerted effort and it begins by reducing pollution and managing the consumption of resources.

A corporate ecological footprint, sustainability footprint, carbon footprint, and the like is determined by the impact its products and business activities have on the planet. Our individual's ecological footprint, sustainability footprint, carbon footprint, and the like is determined largely by the wealth and level of development in the country in which we reside, and by the choices we make about where we live, what we eat, what we wear, how we get around, and what we buy. But this can be influence positively by the choices individuals and their community make in daily living or in the way of doing business. Reducing certain activities related to transportation, housing, food, operating electrical appliances, traveling, driving car, bathing, washing clothes, etc., or making informed choice about the others like food production, water usage, industrial development, etc., can help reduce this ecological footprint.

Achieving carbon neutrality requires a collective engagement focused on making choices and strategic investments at the community level, the corporate level, as well as at the individual level.

Accordingly, in an embodiment, the disclosed methodologies or technologies are directed to employees', employers', suppliers', etc., ecological or carbon footprint reduction and sustainability improvement systems, devices, and methods. In an embodiment, the disclosed methodologies or technologies are directed to systems, devices, and methods for managing an ecological footprint, a sustainability footprint, a carbon footprint, or the like for a community, organization, enterprise, etc., and the individual members of the community, organization, enterprise, and the like.

In an embodiment, the disclosed methodologies or technologies are directed to user-specific and enterprise-wide ecological footprint reduction systems, devices, and methods. In an embodiment, the disclosed methodologies or technologies are directed to selecting, managing, monitoring, and allocating resources (e.g., environmental resources, economical resources, social resources, and the like) to achieve sustainability. In an embodiment, the disclosed methodologies or technologies are directed to reducing consumption of resources and reducing pollution for individuals, communities, enterprises, and the like.

In an embodiment, the disclosed methodologies or technologies are directed to a corporate-wide sustainability improvement or carbon footprint reduction program. In an embodiment, a carbon footprint includes the total amount of greenhouse gas emitted from the production, use, and end-of-life of a product or service.

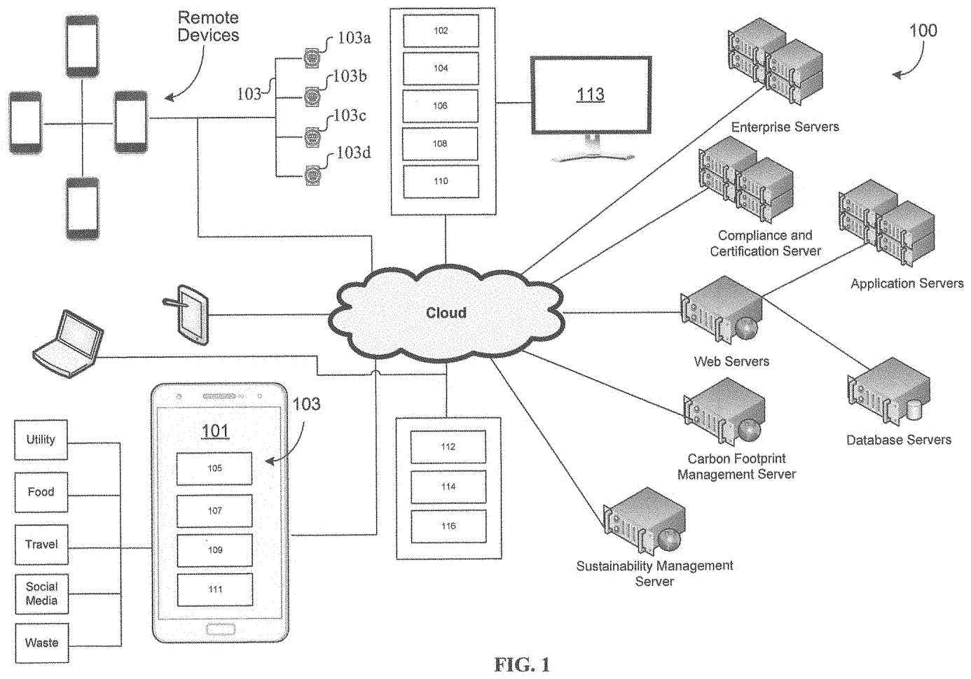

Accordingly, FIG. 1 shows a system 100 in which one or more of the disclosed methodologies or technologies can be implemented such as, for example, managing, monitoring, implementing, or deploying a sustainability footprint, carbon footprint, ecological footprint program; or managing a footprint (e.g., a sustainability footprint, carbon footprint, ecological footprint, and the like) for individual users in an enterprise and the enterprise itself as well as other affiliates, suppliers, customers, collaborates, regulators, related communities, etc.

In an embodiment, the system 100 includes circuitry 102 configured to acquire one or more of user-specific sustainability information, user-specific carbon footprint information, enterprise-wide sustainability information, enterprise-wide carbon footprint information, supplier carbon footprint information, and the like, in an embodiment, the system 100 includes circuitry 104 configured to generate one or more of a user-specific sustainability status, a user-specific carbon footprint status, an enterprise-wide sustainability status, or an enterprise-wide carbon footprint status based on the acquired user-specific sustainability information, the user-specific carbon footprint information, the acquired enterprise sustainability information, or the enterprise carbon footprint information.

In an embodiment, circuitry includes, among other things, one or more computing devices such as a processor (e.g., a microprocessor, and the like), a central processing unit (CPU), a digital signal processor (DSP), an application-specific integrated circuit (ASIC), field programmable gate array (FPGA), or the like, or any combinations thereof, and can include discrete digital analog circuit elements or electronics, or combinations thereof. In an embodiment, circuitry includes one or more ASICs having a plurality of predefined logic components. In an embodiment, circuitry includes one or more FPGAs having a plurality of programmable logic components.

In an embodiment, circuitry includes one or more electrical components operably coupled (e.g., communicatively, electromagnetically, magnetically, ultrasonically, optically inductively, electrically, capacitively coupled, and the like) to each other. In an embodiment, circuitry includes one or more remotely located components. In an embodiment, remotely located components are operably coupled via wireless communication. In an embodiment, remotely located components are operably coupled via one or more receivers, transceivers, or transmitters, antennas, or the like.

In an embodiment, circuitry includes one or more network elements. Non-limiting examples of network elements include Local Area Networks (LANs), network gateway systems, network usage servers, Wide Area Networks (WANs), wireless base stations, wireless relays, and the like. In an embodiment, circuitry includes computer and communication platforms that include data Input/Output (I/O) transceivers, digital processing circuitry, data storage memories, various software components, and the like.

In an embodiment, circuitry includes one or more memory devices that, for example, store instructions or data for example, in an embodiment, the system 100 includes one or more memory devices storing user-specific sustainability information, user-specific carbon footprint information, enterprise-wide sustainability information, or enterprise-wide carbon footprint information with a remote client device and remote server. Non-limiting examples of one or more memory devices include volatile memory (e.g., Random Access Memory (RAM), Dynamic Random-Access Memory (DRAM), or the like); non-volatile memory (e.g., Read-Only Memory (RUM), Electrically Erasable Programmable Read-Only Memory (EEPROM), Flash memory, or the like); persistent memory; or the like. The one or more memory device can be coupled to, for example, one or more computing devices by one or more instructions, data, or power buses.

In an embodiment, where applicable, circuitry includes peripheral devices such as Bluetooth, USB (or other wireless or wired network communication peripherals cable of data exchange with remote client and server computers), and cellular connectivity to exchange data, exchange control commands, configure the system 100, or remotely monitoring or sensor systems 103 (including sensors 103a, 103b, 103c, 103d) parameters. In an embodiment, circuitry includes one or more user input/output components that are operably coupled to the system 100 to generate a user interface that enables access to all user configurable parameters.

In an embodiment, the system 100 includes circuitry configured to exchange information (e.g., sustainability information, carbon footprint information, ecological information, sensor information, compliance information, index information, and the like with one or more enterprise servers, compliance and certification servers, application servers, web servers, database servers, carbon footprint management servers, sustainability management servers, and the like.

In an embodiment, the system 100 includes circuitry configured to exchange one or more of user-specific sustainability information, user-specific carbon footprint information, enterprise-wide sustainability information, or enterprise-wide carbon footprint information with a remote client device and remote server, in an embodiment, the system 100 includes circuitry configured to acquire queue status information from a plurality of remote client devices. Non-limiting examples of client devices include application interface with smart devices, cell phone devices, computer devices, desktop computer devices, internet of things (IoT) devices, laptop computer devices, managed node devices, mobile client devices, notebook computer devices, remote controllers, smart devices, smart eyewear devices, smart wearable devices, tablet devices, wearable devices, and the like. In an embodiment, a client device includes a computer hardware, firmware, software, and the like that accesses a service made available by a server.

In an embodiment, the system 100 includes circuitry configured to receive one or more inputs indicative a sustainability mitigation selection, a carbon footprint mitigation selection, an ecological footprint mitigation selection, and the like. For example, during operation the system 100 generates one or more instance of selectable menus on a GUI that enables users to choose a sustainability mitigation action, which causes the system 100 to generate a protocol or prescriptive action that is predicted to generate a benefit (e.g., reduces a greenhouse gas emission, result in a more sustainable process, etc.) when implemented.

In an embodiment, the system 100 includes circuitry configured to generate a user interface presenting an enterprise-sponsored sustainability mitigation menu and to receive one or more inputs indicative of an enterprise-sponsored sustainability mitigation selection, carbon footprint mitigation selection, ecological footprint mitigation selection, and the like. In an embodiment, the system 100 includes circuitry configured to generate audible instructions. In an embodiment, the system 100 includes circuitry configured to generate haptic feedback. In an embodiment, the system 100 includes circuitry including a screen and a user interface configured to allow a user to visually select settings, modes, and options and interact with a virtual menu including one or more instances of footprint mitigation choices.

In an embodiment, a system 100 includes circuitry configured to initiate a discovery protocol that allows system 100 and one or more devices to find each other and, for example, negotiate one or more pre-shared keys to provide an encrypted secure connection. In an embodiment, individual devices are configured in hardware with a unique identifier to establish a secure IoT connection.

In an embodiment, the system 100 includes circuitry 106 configured to display one or more instances of an aggregate environmental sustainability indicator, an aggregate economic sustainability indicator, or an aggregate social sustainability indicator based on an aggregate of the acquired user-specific sustainability information, the user-specific carbon footprint information, the acquired enterprise sustainability information, and the enterprise carbon footprint information. For example, in an embodiment, the system 100 includes one or more graphical user interfaces (GUIs) 101 that allows users to interact with electronic devices through graphical user interface elements 103. Non-limiting examples of graphical user interface elements 103 include graphical icons 105, menus 107, controls (or widgets) 109, selection enables 111, window, tabs, cursors, and the like.

In an embodiment, the system 100 includes circuitry 10 configured to display one or more instances of a carbon footprint mitigation recommendation and a sustainability mitigation recommendation responsive to a comparison between the user-specific sustainability information, the user-specific carbon footprint information, the enterprise-wide sustainability information, or the enterprise-wide carbon footprint information; and a target user-specific sustainability, a target user-specific carbon footprint, a target enterprise-wide sustainability, or a target enterprise-wide carbon footprint. In an embodiment

In an embodiment, the system 100 includes circuitry 10 configured to display one or more instances of a carbon footprint mitigation recommendation and a sustainability mitigation recommendation includes one or more displays 113. Non-limiting examples of displays include active-matrix organic light-emitting diode (AMOLED) displays, electroluminescent (ELD) displays, holographic displays; light-emitting diode (LED) backlit LCDs, light-emitting diode (LED) displays, liquid crystal displays (LCDs), organic light-emitting diode OLEO displays plasma (PDP) displays, quantum dot (QLED) displays, thin-film transistor (TFT) LCDs virtual displays, and the like.

In an embodiment, the circuitry 108 configured to display one or more instances of a carbon footprint mitigation recommendation and a sustainability recommendation includes circuitry configured to display one or more instances of a user-specific carbon footprint mitigation recommendation and a user specific sustainability recommendation responsive to a comparison between the user-specific sustainability information, the user-specific carbon footprint information, the enterprise-wide sustainability information, or the enterprise-wide carbon footprint information, and a target a target user-specific sustainability, a target user-specific carbon footprint, a target enterprise-wide sustainability, or a target enterprise-wide carbon footprint. In an embodiment, the circuitry 108 configured to display, one or more instances of a carbon footprint mitigation recommendation and a sustainability recommendation includes circuitry configured to display one or more instances of an enterprise-wide carbon footprint mitigation recommendation and an enterprise-wide sustainability recommendation responsive to a comparison between the user-specific sustainability information, the user-specific carbon footprint information, the enterprise-wide sustainability information, or the enterprise-wide carbon footprint information, and a target a target user-specific sustainability, a target user-specific carbon footprint, a target enterprise-wide sustainability, or a target enterprise-wide carbon footprint.

In an embodiment, the system 100 includes menu circuitry 110 configured to generate a user interface presenting a sustainability mitigation menu and to receive one or more inputs indicative of a sustainability mitigation selection. In an embodiment, the menu circuitry 110 is configured to generate a user interface presenting a carbon footprint mitigation menu and to receive one or more inputs indicative of a carbon footprint mitigation selection. In an embodiment, the menu circuitry 110 is configured to generate a user interface presenting an enterprise-sponsored sustainability mitigation menu and to receive one or more inputs indicative of an enterprise-sponsored sustainability mitigation selection.

In an embodiment, the menu circuitry 110 is configured to generate a user interface presenting an enterprise-sponsored carbon footprint mitigation menu and to receive one or more inputs indicative of an enterprise-sponsored carbon footprint mitigation selection. In an embodiment, the menu circuitry 110 is configured to generate a user interface presenting an enterprise-sponsored sustainability mitigation menu and an enterprise-sponsored carbon footprint mitigation menu, and receive one or more inputs indicative of at least one of an enterprise-sponsored sustainability mitigation selection or an enterprise-sponsored carbon footprint mitigation selection.

In an embodiment, the system 100 includes circuitry 112 configured to acquire one or more of user-specific sustainability information, user-specific carbon footprint information, enterprise-wide sustainability information, or enterprise-wide carbon footprint information includes circuitry configured to acquire one or more of user-specific sustainability information, user-specific carbon footprint information, enterprise-wide sustainability information, or enterprise-wide carbon footprint information from a plurality of devices. In an embodiment, the circuitry 112 configured to acquire one or more of user-specific sustainability information, user-specific carbon footprint information, enterprise-wide sustainability information, or enterprise-wide carbon footprint information includes circuitry configured to acquire one or more of user-specific sustainability information, user-specific carbon footprint information, enterprise-wide sustainability information, or enterprise-wide carbon footprint information from a plurality of remote devices. In an embodiment, the circuitry 112 configured to acquire one or more of user-specific sustainability information, user-specific carbon footprint information, enterprise-wide sustainability information, or enterprise-wide carbon footprint information includes circuitry configured to acquire one or more of user-specific sustainability information, user-specific carbon footprint information, enterprise-wide sustainability information, or enterprise-wide carbon footprint information from a plurality of remote network servers.

In an embodiment, the system 100 includes circuitry 114 configured to display one or more instances of a carbon footprint achievement level and a sustainability achievement level responsive to a comparison between the user-specific sustainability information, the user-specific carbon footprint information, the enterprise-wide sustainability information, or the enterprise-wide carbon footprint information; and a target user-specific sustainability, a target user-specific carbon footprint, a target enterprise-wide sustainability, or a target enterprise-wide carbon footprint. In an embodiment, the circuitry 114 is configured to display one or more instances of a user-specific and enterprise-wide carbon footprint achievement level and user-specific and enterprise-wide sustainability achievement level responsive to a comparison between the user-specific sustainability information, the user-specific carbon footprint information, the enterprise-wide sustainability information, or the enterprise-wide carbon footprint information; and a target user-specific sustainability, a target user-specific carbon footprint, a target enterprise-wide sustainability, or a target enterprise-wide carbon footprint. In an embodiment, the system 100 includes circuitry 116 configured to generate a collective user-specific carbon footprint credit status for one or more users and to generate an enterprise-wide carbon footprint credit status based in part on the acquired user-specific sustainability information, the user-specific carbon footprint information, the acquired enterprise sustainability information, or the enterprise carbon footprint information.

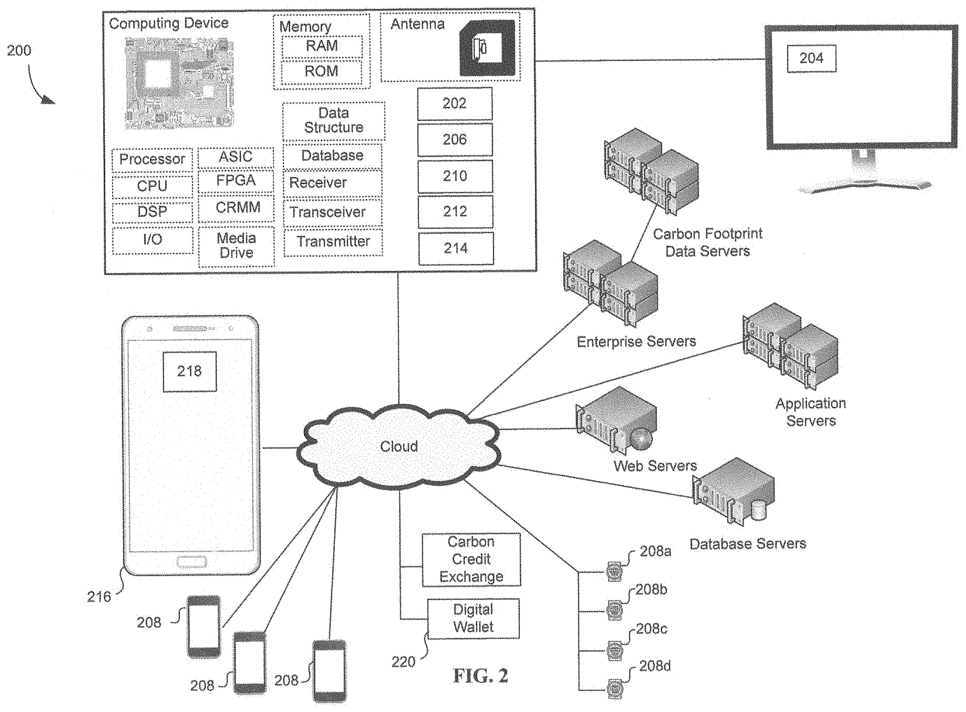

FIG. 2 shows a sustainability and carbon footprint management system 200 in which one or more of the disclosed methodologies or technologies can be implemented. In an embodiment, a sustainability and carbon footprint management system 200 includes an aggregate sustainability and carbon footprint status unit circuitry 202 configured to acquire one or more of employee sustainability information, employee carbon footprint information, employer sustainability information, or employer carbon footprint information, and generate one or more of an employee sustainability status, an employee carbon footprint status, an employer sustainability status, or an employer carbon footprint status based on the acquired employee sustainability information, the acquired employee carbon footprint information, the acquired employer sustainability information, or the acquired employer carbon footprint information In an embodiment, the aggregate sustainability and carbon footprint mitigation unit 302 is configured to display one or more instances 204 of a carbon footprint mitigation recommendation and a sustainability mitigation recommendation responsive to a comparison between the acquired employee sustainability information, the acquired employee carbon footprint information, the acquired employer sustainability information, or the acquired employer carbon footprint information; and target sustainability information or a target carbon footprint information.

In an embodiment, a system 200 includes a collective sustainability unit 206 configured to acquire sustainability information from a plurality of remote devices 20 and to generate user-specific sustainability information or user-specific carbon footprint information based in part on the acquired sustainability information or carbon footprint information. In an embodiment, the collective sustainability unit 206 includes computational circuitry configured to acquire sustainability information from a plurality of remote devices and to generate user-specific sustainability information or user-specific carbon footprint information based in part on the acquired sustainability information or carbon footprint information. In an embodiment, the collective carbon footprint unit includes computational circuitry configured to computational circuitry configured to acquire carbon footprint information from the plurality of remote devices, and to generate enterprise-wide sustainability information or enterprise-wide carbon footprint information based in part on the acquired sustainability information or carbon footprint information. In an embodiment, the collective sustainability unit 206 includes computational circuitry configured to acquire the carbon footprint information from a plurality of remote sensors. In an embodiment, the collective carbon footprint unit includes computational circuitry configured to acquire the carbon footprint information from a plurality of remote sensors.

In an embodiment, a system 200 includes a collective carbon footprint unit 210 configured to acquire carbon footprint information from the plurality of remote devices 208a, 208b, 208c, 208d and to generate enterprise-wide sustainability information or enterprise-wide carbon footprint information based in part on the acquired sustainability information or carbon footprint information. In an embodiment, the system 200 includes a carbon footprint unit 210 configured to quantify carbon credits associated with the acquired sustainability information or the acquired carbon footprint information. In an embodiment, the system 100 includes a collective carbon footprint credit unit 212 configured to manage user-specific carbon credits and enterprise-wide carbon credits associated with enterprise-wide acquired sustainability information or carbon footprint information.

In an embodiment, the collective carbon footprint unit 210 includes computational circuitry configured to acquire the carbon footprint information from a plurality of remote imaging sensors configured to convert a digital image of an output from a utility meter to carbon footprint information. In an embodiment, the collective carbon footprint unit 210 includes computational circuitry configured to acquire the carbon footprint information from one or more utility meters (e.g., electricity meters, natural gas meters, fuel meters, smart utility meters, and the like). In an embodiment, the collective carbon footprint unit 210 includes computational circuitry configured to acquire the carbon footprint information from one or more meters configured to record consumption of electric energy, fuel oil, natural gas, water, and the like. In an embodiment, the collective carbon footprint unit 210 includes computational circuitry configured to acquire the carbon footprint information from one or more meters configured to record sewage generation information, wastewater generation information, or garbage generation information.

In an embodiment, the system 200 includes a carbon credit unit 214 configured to facilitating payment to a digital wallet responsive to receiving one or more inputs indicative of transaction for to buy or sell user-specific carbon credits or enterprise-wide carbon credits. In an embodiment, the carbon credit unit 214 is configured to configured to broadcast a request to sell user-specific carbon credits. In an embodiment, the carbon credit unit 214 is configured to broadcast to one or more client devices a request to buy or sell user-specific carbon credits or enterprise wide carbon credits. In an embodiment, the carbon credit unit 214 is configured to broadcast to one or more enterprise devices a request to buy or sell user-specific carbon credits to an enterprise.

In an embodiment, the carbon credit unit 214 is configured to update a blockchain transaction associated with a virtual carbon credit wallet. In an embodiment, the carbon credit unit 214 includes computational circuitry having a processor configured to modify a blockchain entry associated with a user-specific carbon credit or enterprise-wide carbon credit responsive to receiving the one or more inputs indicative of an acceptance to an offer to sell or buy a user-specific carbon credit.

In an embodiment, the carbon credit unit 214 includes computational circuitry having a processor configured to modify a virtual user-specific carbon credit wallet 220 or enterprise-wide carbon credit wallet responsive to receiving the one or more inputs indicative of an acceptance to an offer to sell or buy a user-specific carbon credit. In an embodiment, the carbon credit unit includes a blockchain validation system wherein a payment process uses at, least in part a blockchain-based cryptocurrency exchange. In an embodiment, the carbon credit unit includes at least part of a blockchain-based cryptocurrency payment process.

In an embodiment, the carbon credit unit 214 includes computational circuitry having a transceiver configured to broadcast to one or more client devices the request to purchase user-specific carbon credits from one or more users. In Un embodiment, the carbon credit unit 214 includes computational circuitry and a processor configured to modify a virtual user-specific carbon credit wallet or enterprise-wide carbon credit wallet responsive to receiving the one or more inputs indicative of an acceptance to an offer to sell or buy a user-specific carbon credit.

In an embodiment, the system 200 includes a user interface 216 presenting one or more instances 218 of user-specific carbon credits or enterprise-wide carbon credits.

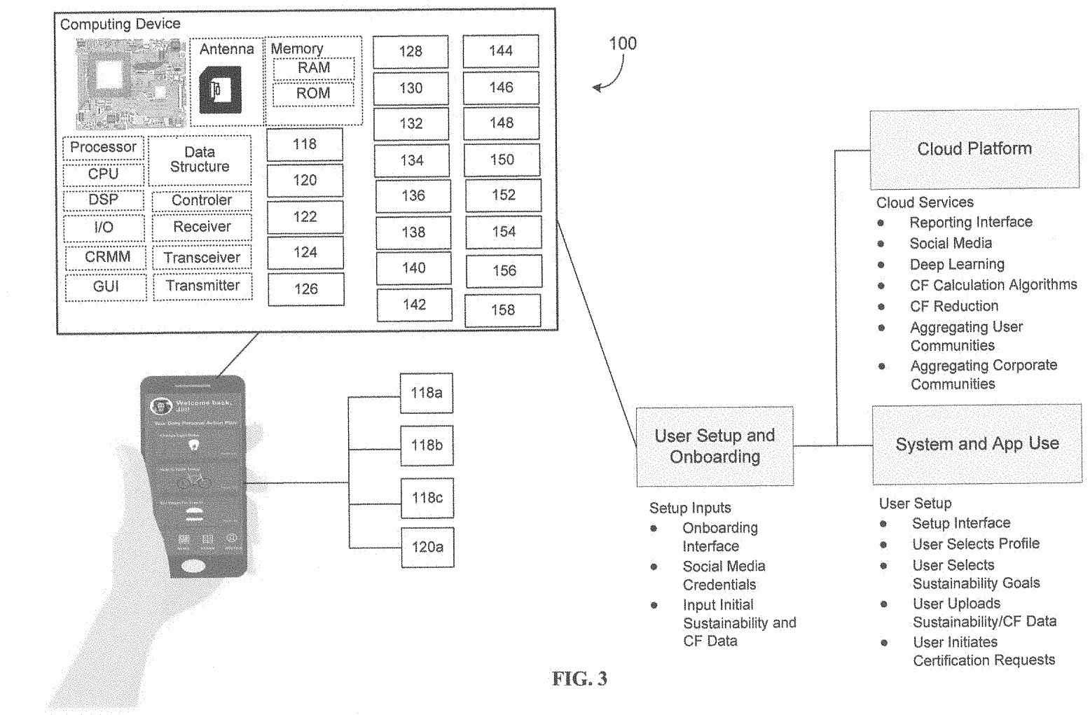

FIG. 3 show a system 100 in which one or more of the disclosed methodologies or technologies can be implemented. In an embodiment, the system 100 includes computational circuitry 118 configured to display one or more instances 118a of a predicted environmental sustainability measure, a predicted economic sustainability measure 118b, or a predicted social sustainability measure 118c responsive to acquiring the sustainability information or the carbon footprint information

In an embodiment, the system 100 includes menu circuitry 120 configured to generate a user interface presenting an enterprise-sponsored sustainability mitigation menu 120a and an enterprise-sponsored carbon footprint mitigation menu, and receive one or more inputs indicative of at least one of an enterprise-sponsored sustainability mitigation selection or an enterprise-sponsored carbon footprint mitigation selection.

In an embodiment, a system 100 includes computational circuitry 122 configured to configured to display one or more instances of a user-specific sustainability information and enterprise-wide sustainability information. In an embodiment, a system 100 includes computational circuitry configured to display one or more instances of a user-specific carbon footprint information and enterprise-wide carbon footprint information.

In an embodiment, a sustainability and carbon footprint management system includes circuitry 124 configured to initiate one or more push notices representing an enterprise-wide sustainability rating and a user-specific sustainability rating responsive to receiving sustainability information from a plurality of remote devices. In an embodiment, a sustainability and carbon footprint management system includes circuitry configured to initiate one or more push notices representing an enterprise-wide carbon footprint rating and a user-specific carbon footprint rating responsive to receiving carbon footprint information from the plurality of remote devices.

In an embodiment, a system 100 includes a sustainability unit 126 configured to determine a sustainability score based one or more inputs indicative of a social, environmental, or economic activity. In an embodiment, the sustainability unit 126 includes computational circuitry configured determine a sustainability score based one or more inputs indicative of a social, environmental, or economic activity.

In an embodiment, the system 100 includes a controller with at east one processor, transceiver, and memory for storing data including executable instructions for any of the disclosed methods. In an embodiment, the system 100 includes a controller with at least one processor, transceiver, and memory for storing data including executable instructions for monitoring consumption data associated with each managed user-specific and enterprise-wide energy consuming device.

In an embodiment, the sustainability unit 126 includes computational circuitry configured determine a sustainability score based one or more inputs indicative of food consumption activity, in an embodiment, the sustainability unit includes computational circuitry configured determine a sustainability score based one or more inputs indicative of household emissions activity. In an embodiment, the sustainability unit 126 includes computational circuitry configured determine a sustainability score based one or more inputs indicative of personal transportation activity. In an embodiment, the sustainability unit 126 includes computational circuitry configured determine a sustainability score based one or more inputs indicative of a work-related social, environmental, or economic activity.

In an embodiment, the system 100 includes a carbon footprint unit 128 configured to determine a carbon footprint score based one or more inputs indicative of a greenhouse gas emissions activity. In an embodiment, the carbon footprint unit 128 includes computational circuitry configured determine a carbon footprint score based one or more inputs indicative of a greenhouse gas emissions activity. Non-limiting examples of greenhouse gas emitted includes carbon dioxide, methane, nitrous oxide, fluorinated gases, and the like. Further Non-limiting examples of greenhouse gas include Carbon dioxide (CO2), Chlorofluorocarbons (CFCs), Hydrofluorocarbons (includes HCFCs and HFCs), Methane (CH4), Nitrous oxide (N2O), Ozone (O3), Water vapor (H2O) and the like. Further Non-limiting examples of greenhouse gas include gases which trap heat in the atmosphere, causing global warming. See e.g., Center for Sustainable Systems, University of Michigan. 2020. “Greenhouse Gases Factsheet.” Pub. No. CSS05:21 (the contents of which are incorporated herein by reference in their entirety.) In an embodiment, the carbon footprint unit 128 includes computational circuitry configured to determine a carbon footprint score based one or more inputs indicative of a work-related greenhouse gas emissions activity. In an embodiment, the carbon footprint unit 128 includes computational circuitry configured to determine a global warming potential (GWP) of each gas in units of carbon dioxide equivalents (CO2e), giving carbon footprints a single unit for easy comparison.

In an embodiment, the system 100 includes a personal lifetime footprint (e.g., a sustainability footprint, carbon footprint, ecological footprint, and the like) unit 130 configured to manage (determine and store) a user's lifetime carbon footprint information. In an embodiment, the system 100 includes an enterprise lifetime carbon footprint unit 132 configured to manage an enterprise's lifetime carbon footprint information. In an embodiment, the system 100 includes a commute carbon footprint unit 134 including computational circuitry configured determine a carbon footprint associated with a daily commute. In an embodiment, the system 100 includes a consumer goods carbon footprint unit 136 including computational circuitry configured determine a carbon footprint associated with a consumer good responsive to one or more inputs associated with a specific consumer good. (scan products).

In an embodiment, the system 100 includes a recycle carbon footprint unit 138 including computational circuitry configured determine a carbon footprint associated with the contents of an aggregate of recyclable materials. In an embodiment, the system 100 is operably coupled to an imaging device configured to capture images of the contents of a recycle bin, waste material pile, and the like and identify specific object in the recycle bin or waste material pile using image recognition algorithms, and to determine carbon footprint information associated with the specific objects.

In an embodiment, the system 100 includes a carbon footprint unit 140 operably coupled to one or more remote sensors to obtain greenhouse emission information, such as utility meters, energy uses meters, temperature sensor, emissions sensor and the like.

In an embodiment, the system 100 includes an employer footprint unit 142 including computational circuitry configured determine a carbon footprint associated with an employer. In an embodiment; the system 100 includes a general footprint unit 144. In an embodiment, the system 100 includes a personal habits footprint unit 146 including computational circuitry configured determine a carbon footprint associated with a user's consumption habits. In an embodiment, the system 100 includes a home footprint unit 148 including computational circuitry configured determine a carbon footprint associated with a home consumption.

In an embodiment, the system 100 includes a social media use footprint unit 150 (couple to mobile phone, tablet, wearable, wireless device including computational circuitry configured to determine a carbon footprint associated with social media use. In an embodiment, the system 100 includes a benchmark footprint unit 152 including computational circuitry configured determine a carbon footprint based on a companion of actual use information and one or more benchmarks in an embodiment, the system 100 includes a sustainability unit 154 including computational circuitry configured determine a sustainably footprint.

In an embodiment, the system 100 includes computational circuitry 156 configured to initiate a user setup and onboarding protocol, in an embodiment, the system 100 includes computational circuitry 156 configured to initiate a user experience protocol, a user setup protocol, a sustainability data exchange protocol, and the like.

In an embodiment, the system 100 includes computational circuitry 158 configured to initiate a cloud service protocol including Cloud Services initiation Reporting interface, a Social Media exchange, a Deep Learning applications for predicting sustainability data, carbon footprint (CF) Calculation Algorithms; CT Reduction protocols, Aggregating User Communities, Aggregating Corporate Communities, and the like.

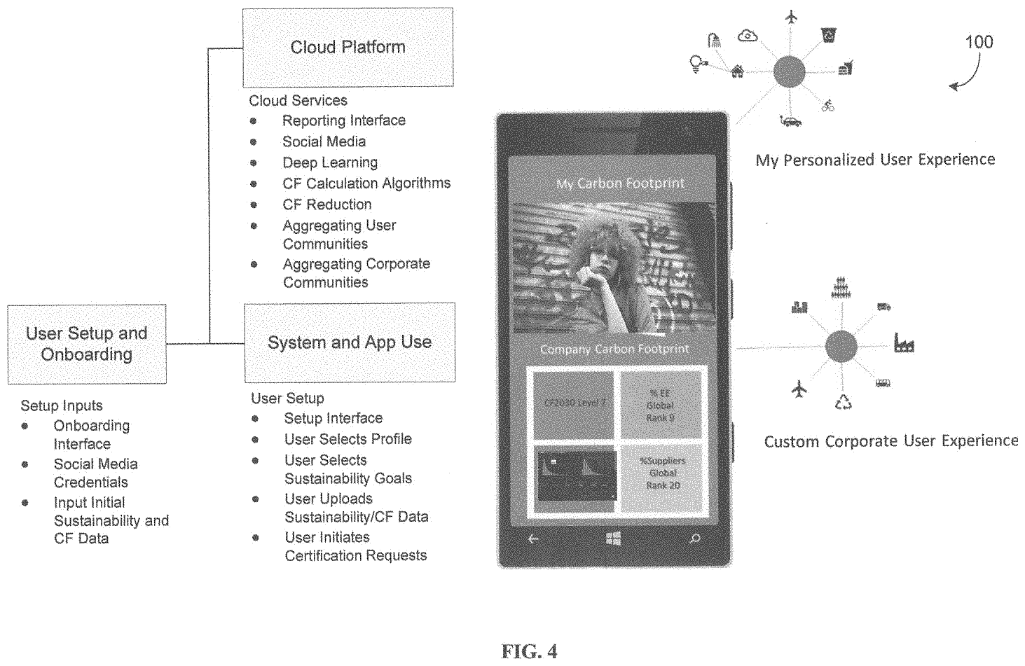

Referring to FIG. 4, in an embodiment; the system 100 includes circuitry to enable onboarding via social media authentication; user setup and personalization, and enabling cloud services.

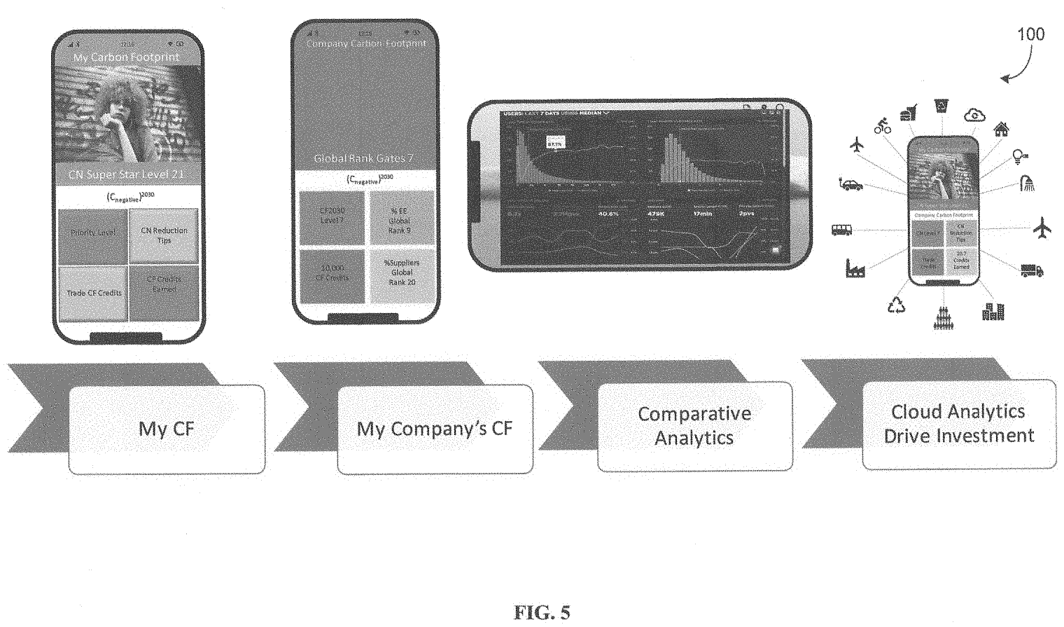

FIG. 5 shows a schematic diagram of a sustainability and carbon footprint management system 100 in which one or more of the disclosed methodologies or technologies can be implemented.

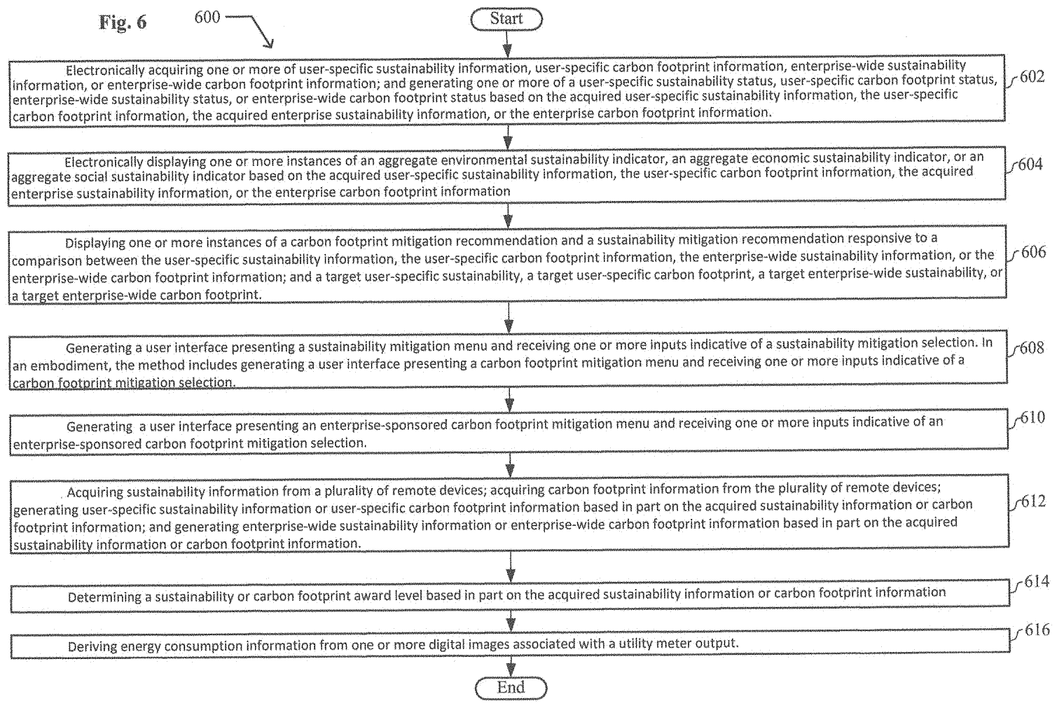

Referring to FIG. 6, at 602 method 600 includes electronically acquiring one or more of user-specific sustainability information, user-specific carbon footprint information, enterprise-wide sustainability information, or enterprise-wide carbon footprint information; and generating one or more of a user-specific sustainability status, user-specific carbon footprint status, enterprise-wide sustainability status, or enterprise-wide carbon footprint status based on the acquired user-specific sustainability information, the user-specific carbon footprint information, the acquired enterprise sustainability information, or the enterprise carbon footprint information.

At 604 method 600 includes electronically displaying one or more instances of an aggregate environmental sustainability indicator, an aggregate economic sustainability indicator, or an aggregate social sustainability indicator based on the acquired user-specific sustainability information, the user-specific carbon footprint information, the acquired enterprise sustainability information, or the enterprise carbon footprint information.

At 606 method 600 includes electronically displaying one or more instances of a carbon footprint mitigation recommendation and a sustainability mitigation recommendation responsive to a comparison between the user-specific sustainability information, the user-specific carbon footprint information, the enterprise-wide sustainability information, or the enterprise-wide carbon footprint information; and a target user-specific sustainability, a target user-specific carbon footprint, a target enterprise-wide sustainability, or a target enterprise-wide carbon footprint.

At 608 method 600 includes generating a user interface presenting a sustainability mitigation menu and receiving one or more inputs indicative of a sustainability mitigation selection. In an embodiment, the method includes generating a user interface presenting a carbon footprint mitigation menu and receiving one or more inputs indicative of a carbon footprint mitigation selection. In an embodiment, the method includes generating a 15 is user interface presenting an enterprise-sponsored sustainability mitigation menu and receiving one or more inputs indicative of an enterprise-sponsored sustainability mitigation selection.

At 610 method 600 includes generating a user interface presenting an enterprise-sponsored carbon footprint mitigation menu and receiving one or more inputs indicative of an enterprise-sponsored carbon footprint mitigation selection. In an embodiment, a method includes generating a user interface presenting an enterprise-sponsored sustainability mitigation menu and an enterprise-sponsored carbon footprint mitigation menu, and receiving one or more inputs indicative of at least one of an enterprise-sponsored sustainability mitigation selection or an enterprise-sponsored carbon footprint mitigation selection.

At 612 method 600 includes acquiring sustainability information from a plurality of remote devices; acquiring carbon footprint information from the plurality of remote devices; generating user-specific sustainability information or user-specific carbon footprint information based in part on the acquired sustainability information or carbon footprint information; and generating enterprise-wide sustainability information or enterprise-wide carbon footprint information based in part on the acquired sustainability information or carbon footprint information.

At 614 method 600 includes determining a sustainability or carbon footprint award level based in part on the acquired sustainability information or carbon footprint information.

At 616 method 600 includes deriving energy consumption information from one or more digital images associated with a utility meter output. In an embodiment, the method includes deriving energy consumption information from one or more digital images associated with waste materials. In an embodiment, the method includes deriving energy consumption information from one or more digital images associated with compost materials.

In an embodiment, a method for an enterprise-wide carbon footprint management system includes acquiring carbon footprint information from a plurality of devices; determining enterprise-wide carbon footprint information based on an aggregate of the footprint information from the plurality of remote user devices; and generating one or more instances indicative of a comparison between a modeled carbon footprint of and an actual.

Examples of Approaches for Calculating Ecological Footprint: (Source: EPA Emissions Factors for Greenhouse Gases Inventories 2018¹) ¹ https://carbonfund.org/calculation-methods/

### Home and Office Energy Usage

Electricity² ² Emissions calculated from electricity generation with the EPA's eGRiD emission factors based on 2016 data published in 2018 (the contents of which are incorporated herein by reference in their entirety.)
US average electricity source emissions of 0.9884 lbs CO2 per kWh (0.4483 kgs CO2 per kWh).

### Heating Oil

There are 10.16 kgs of CO2 per gallon of home heating oil. (Source: U.S. Department et Energy)

### Natural Gas

Then: are 0.00531 metric tonnes of CO2 per 100 cubic feet (CCF) of natural gas. (Source: U.S. Department of Energy)

### Propane

There rare 0.00576 metric tonnes of CO2 per gallon of propane. (Source: U.S. Department of Energy)

### Travel

### Vehicles

Unleaded automobile gasoline emits 8.78 kgs CO2 per gallon. Diesel fuel emits 10.21 kgs CO2 per gallon.

### Air Travel

CO2 emissions for coach/economy air travel vary by length of flight, ranging, from 0.137 kgs CO2e per passenger mile to 0.227 kgs CO2e per passenger mile, with higher emissions for shorter flight segments. Our calculator uses a simplified factor of 0.2 kgs per passenger mile.

### Rail Travel

The CO2 emissions for ion distance trains (i.e., intercity rail) is 0.14 kgs per passenger mile.

### Product Shipments

Product shipping emissions is calculated by the total number of parcels multiplied by the average parcel weight and average parcel shipping distance then by the applicable emissions factor per ton-mile.
Groundtruck shipping emissions factor is 0.202 kgs/ton-mile
Air shipping emissions factor is 1.32 kgs/ton-mile
Ocean/water shipping emissions factor is 0.0603 kgs/ton-mile

### Total US CO2-Equivalent Emissions:

In 2014, US energy-related emissions totaled 6.87 billion metric tonnes CO2-equivalent.³ ³ Source: US Environmental Protection Agency/US Census Bureau) To ensure that estimated data fully compensates for an individual's annual carbon footprint, we add 10% to these calculations.

### Hospitality

### Meals

The average person's diet contributes 2,545 kilograms CO2e to the atmosphere each year (7 kg CO2e/Day.⁴ ⁴ This calculation is based on an average US, non-vegetarian diet. The emissions for food preparation are not included in this calculation, Source: John Hopkins Bloomberg School of Public Health, Average of Table 3). (the contents of which are incorporated herein by reference in their entirety.)

### Hotel Rooms

Emissions associated with a one night stay in a hotel room are calculated at 15.13 kg CO2 per room day for an average US-based hotel (budget through mid-scale). For upscale US-based hotels, which include restaurants, meal service and meeting space, emissions are calculated t 26.6 kg CO2 per room day.⁵ ⁵ Source: Environmental Protection Agency, CHP Potential in the Hotel and Casino Market Sectors, prepared by Energy and Environmental Analysis, Inc. for EPA.) More specific hotel room-night emissions can be calculated by property or location using the Cornell Hotel Sustainability Benchmarking (CHSB) study (the contents of which are incorporated herein by reference in their entirety.) and this online hotel emissions calculator: (n.d.). Retrieved Jan. 9, 2021, from https://www.hotelfootprints.org/benchmarking (the contents of which are incorporated herein by reference in their entirety.).

### Shipping Calculator

Carbonfund.org's shipping calculator utilizes three user generated inputs to determine a unit called a ‘tonne-mile’ (e.g. a tonne of freight traveling 1 mile, or a half tonne of freight traveling two miles, or 1/1000th of a tonne Traveling 1,000 miles . . . you get the point):

Total number of shipments

Avg Weight of Shipment (lbs)

Avg Shipping Distance (ml)

### Shipping Emissions Factors

Air cargo—1.319 kg CO2e per Ton-Mile

Truck—0,202 kg CO2e per Ton-Mile

Train—0.0242 kg CO2e per Ton-Mile

Sea freight—0.0603 kgs CO2e per Ton-Mile

### (Source: EPA Climate Leaners)

### Conversions

1 Renewable Energy Certificate=1 Megawatt Hour (MWh)=1,000 Kilowatt Hours (KWh)

1 Kilowatt Hour=3,413 British Thermal Units (BTUs)

1 Metric Tonne=2,204.6 Pounds

1 Pound=0.00045 Metric Tonnes

1 Short Ton=2,000 Pounds

1 Short Ton=0.90719 Metric Tonnes

1 Therm=100 Cubic. Feet

1 CCF=Abbreviation for 100 Cubic Feet

1 CCF=1.024 Therms

### Business Calculator

### Office Emissions

All emissions factors in the “Office Emissions” category are based on annual (12 month) emissions. Emissions factors for energy (kWh) are based on state-based figures from the EPA eGRID

### Natural Gas

There are 0.00531 metric tonnes of CO2 per 100 cubic feet (CCF) of natural gas. (Source: U.S. Department of Energy)

### Electricity

Emissions factors for electricity by your monthly bill are based on state based figures from the EPA eGRID to get the state-by-state prices for energy, and the emissions factors are generated from the Department of Energy's Energy information Administration. On average, electricity sources emit 1.222 lbs CO2 per kWh. State CO2 emissions per kWh may vary greatly in accordance with the amount of clean energy in the energy supply (Vermont: 0.0055 lbs/kWh; North Dakota: 2.0685 lbs/kWh). (Source: (Source: EPA eGRID Summary Tables and Data Files)

### Heating Oil

There are 10.16 kg of CO2 per gallon of home heating oil (diesel fuel). (Source: US DOE 1605(b) Voluntary Reporting of Greenhouse Gases Program.)

### Propane

There are 0.00576 metric tonnes of CO2 per gallon of propane. (Source: U.S. Department of Energy)

### Servers

Server emissions are calculated assuming an average 251 watt server (source: Vertatique) with 95% up time. The energy usage of each server is then multiplied by state based emissions factors.

### Fleet

Fleet emission calculations assume the national average of 25.2 mpg and the emissions factor of 19.4 lbs CO2 per gallon of gasoline consumed. Fleet emissions for delivery vans and trucks assume an average of 18.8 mpg. and the emissions factor of 22.2 lbs CO2 per gallon of diesel consumed. Fleet emissions big rigs assume an average of 5.4 mpg and the emissions factor of 22.2 lbs CO2 per gallon of diesel consumed. (Source: Transportation Data Energy Book 2015 Quick Facts)

### Employee Travel

Ail travel emissions factors sourced from EPA Climate Leaders.
Short flights are calculated to be under 300 miles one-way with emissions of 0.254 kg CO2e per passenger mile
Medium flights are calculated to be 300-2300 miles one-way, average 1500 miles, with emissions of 0.144 kg CO2e per passenger mile
Long flights are calculated to be >2300 miles, average 3,000 miles one-way with emissions of 0.169 kg CO2e per passenger mile
Train trips are calculated 0.17 kg CO2e per passenger mile
Subway trips are calculated 0.121 kg CO2e per passenger mile
Bus trips are calculated at 0.055 kg CO2e per passenger mile

### Employee Commute

All emissions figures from EPA Climate Leaders.
Commute by Car assumes 036 kg CO2e of gas consumed per mile and a two-way commute 245 days a year. (The kg CO2/vehicle mile average of both passenger car and light-duty truck.)
Commute by intercity Rail (Amtrak) assumes a two-way commute 245 days a year, with 0.137 kg CO2e emitted per mile.
Commuter Rail Assumes a two-way commute 345 days a year; with 0.17 kg of CO2e emitted per mile.
Commute by Transit (tram, subway) assumes a two-way commute 245 days a year, with 0.121 kg of CO2e emitted per mile.
   individual indicators: See e.g., “Circles of Sustainability.” Wikipedia, Wikimedia Foundation, 22 Jul. 2020, en.wikipedia.org/wiki/Circles_of_Sustainability; See also, Center for Sustainable Systems, University of Michigan. 2020. “Greenhouse Gases Factsheet.” Pub. No. CSS05-21. (the contents of each of which are incorporated herein by reference in their entirety.) There are indicators that individuals, families, and communities can use to measure the sustainability of their lifestyles.
More should be done to help each person develop and use such indicators to manage their own well-being and sustainability.
Such indicators can also contribute substantially to education for sustainable development.
Examples of individual indicators
Environmental Indicators
Water consumption, use of polluting materials (detergent, cleaners, toxics)
Energy: Electricity/gas consumption, heating bills, CO2 budget
Transport: automobile mileage, public transport use, bicycle use, walking
Food: purchases of fast food, organic, fair trade; weight gain; number of meatless meals
Clothing: number of shirts, dresses, shoes; expenditures on clothes
Housing: number of rooms per person, cost
Technology: number of electronic devices bought/discarded
Contact with nature, animals (hrs/week)
Travel for recreation, tourism (km)
Experiences of beauty, cultural diversity
Community: participation in activities
Solidarity: gifts to charity, development
Altruism: volunteer service
Spirituality: daily prayer

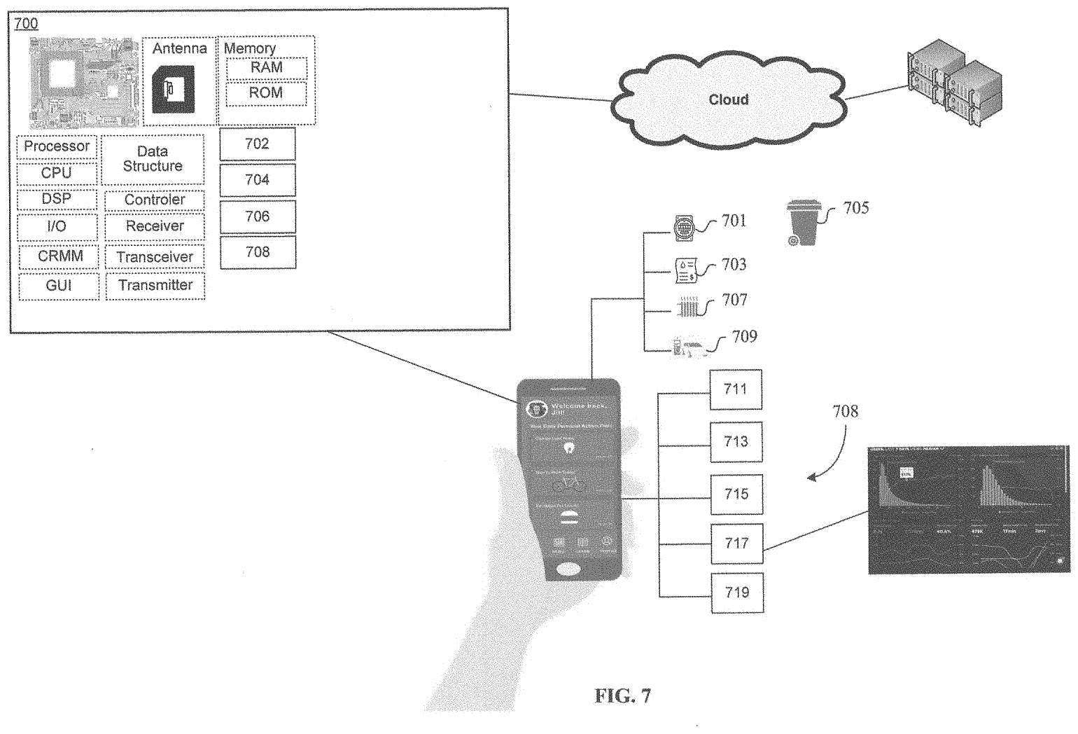

FIG. 7 show a sustainability standard compliance system 700 in which one or more methodologies or technologies can be implemented such as, for example, implementing a sustainability standard compliance system for individual user in an enterprise and the enterprise itself as well as other affiliates, suppliers, customers, collaborates, related communities, etc.

In an embodiment, the sustainability standard compliance system 700 includes a sustainability index unit 702 including computational circuitry configured to predict a sustainability index. In an embodiment, the predicted sustainability index comprises at least one indicator or measure of the quality of data used to predict the suitability index, in an embodiment, the predicted sustainability index comprises at least one indicator or measure of the source of data used to predict the suitability index. In an embodiment, the predicted sustainability index comprises at least one indicator of a severity of a condition affecting a sustainability index. In an embodiment, the predicted sustainability index comprises at least one indicator of a Scope 1 emissions event, Scope 2 emissions event, or Scope 3 emissions event. In an embodiment, the predicted sustainability index comprises at least one indicator of a predicted sustainability maturity level. In an embodiment, the predicted sustainability index comprises at least one indicator of a predicted overall sustainability maturity level. In an embodiment, the predicted sustainability index comprises at least one indicator of a sustainability area specific maturity level.

In an embodiment, the predicted sustainability index comprises at least one indicator of a social media reputation index

In an embodiment, Scope 1 emissions include direct greenhouse gas emissions released to the atmosphere resulting from enterprise-owned and controlled resources. Non-limiting examples of Scope 1 emissions include emission due to stationary combustion (e.g., fuels, heating sources, fuels that produce GHG emissions, etc.) mobile combustion (e.g., vehicles owned or controlled by a firm, burning fuel), fugitive emissions leaks from greenhouse gases (e.g. refrigeration, air conditioning units)), and process emissions (e.g., emissions released during industrial processes, and on-site manufacturing.). In an embodiment, Scope 2 emissions include indirect greenhouse gas emissions resulting from the consumption of purchased electricity, steam, heat and cooling.

In an embodiment, Scope 3 emissions include are all indirect greenhouse gas—not owned not included in scope 2—that occur in the value chain of the reporting company, including both upstream and downstream emissions. In other words, emissions that are linked to the company's operations. According to GHG protocol, scope 3 emissions are separated into 15 categories (Purchased goods and services, Capital goods, Fuel- and energy related activities (not included in scope 1 or scope 2), Upstream, transportation, and distribution, Waste generated in operations, Business travel, Employee commuting, Upstream leased assets, Downstream transportation and distribution: Processing of said products, Use of sold products, End-of-life treatment of sold products, Downstream leased assets, and Franchises.)

In an embodiment, the sustainability index unit 702 comprises computational circuitry configured to predict a sustainability index based on one or more inputs indicative of a greenhouse gas emissions activity or a sustainability activity.

In an embodiment, the sustainability index unit 702 comprises computational circuitry configured to derive energy consumption information from one or more digital images associated with a utility meter 701 output. In an embodiment, the sustainability index unit 702 comprises computational circuitry configured to derive energy consumption information from one or more digital images associated with a utility bill or an invoice 703. In an embodiment, the sustainability index unit 702 comprises computational circuitry configured to predict a sustainability index and a data validation score based on information extracted from one or more digital images associated with a utility bill or services invoice 703.

In an embodiment, the sustainability index unit 702 comprises computational circuitry configured to predict a sustainability index and a data validation score based on information associated with an image of a machine-readable symbol. In an embodiment, the sustainability index unit 702 comprises computational circuitry configured to predict a sustainability index and a data validation score based on information associated with a product barcode.

In an embodiment, the sustainability index unit 702 comprises computational circuitry configured to derive energy consumption information from one or more digital images associated with waste materials 705. In an embodiment, the sustainability index unit 702 comprises computational circuitry configured to extract energy consumption information from the one or more digital images using pixel by pixel analysis to identify specific waste materials imaged in the image and to look up a carbon footprint burden associated with the identified waste materials. In an embodiment, the sustainability index unit 702 comprises computational circuitry configured to derive energy consumption information from one of more digital images associated with compost materials. In an embodiment, the sustainability index unit 702 comprises computational circuitry configured to derive energy consumption information from one or more digital images associated with a utility meter 701 output.

In an embodiment, the sustainability index unit 702 comprises computational circuitry configured to extract energy consumption information from the one or more digital images associated with a utility meter output using pixel by pixel analysis to identify meter reading data and to determine a carbon footprint burden associated with the meter reading 707 data.

In an embodiment, the sustainability index unit 702 comprises computational circuitry configured to derive g energy consumption information from one or more digital images associated with waste materials. In an embodiment, the sustainability index unit 702 comprises computational circuitry configured to derive energy consumption information from one or more digital images associated with compost materials, in an embodiment, the sustainability index unit 702 comprises computational circuitry configured to derive energy consumption information from one or more digital images associated with a vehicle meter 709 output.

In an embodiment, the sustainability index unit 702 comprises computational circuitry configured to derive g energy consumption information from one or more digital images associated with waste materials 705.

In an embodiment, the sustainability index unit 702 comprises computational circuitry configured to derive energy consumption information from one or more digital images associated with compost materials.

In an embodiment, the sustainability index unit 702 comprises computational circuitry configured to predict a carbon footprint index based one or more inputs indicative of a greenhouse gas emissions activity. In an embodiment, the sustainability index unit 702 comprises computational circuitry configured to predict a carbon footprint severity index based one or more inputs indicative of a severe condition associated with a greenhouse gas emissions activity. In an embodiment, the sustainability index unit 702 comprises computational circuitry configured to predict a carbon footprint mitigation maturity level based one or more inputs indicative of a greenhouse gas emissions activity.

In an embodiment, the sustainability index unit 702 comprises computational circuitry configured to determine a sustainability index based one or more inputs indicative of a social, environmental, or economic activity affecting a sustainability measure.

In an embodiment, the sustainability standard compliance system 700 includes a sustainability dashboard unit 704 including computational circuitry configured to generate one or more instances 708 of the predict sustainability index on a virtual display. For example, in an embodiment, the sustainability dashboard unit 704 comprises computational circuitry configured to generate one or more instances 711 of the predict sustainability index on a virtual display. In an embodiment, the sustainability dashboard unit 704 comprises s computational circuitry configured to generate one or more instances 713 of the predict a carbon footprint index on a virtual display. In an embodiment, the sustainability dashboard unit 704 comprises computational circuitry configured to generate one or more instances 715 of a predict sustainability; an indicator or measure of the source of data used to predict the suitability index; a input data validity score; an indicator of a maturity state; an indicator of an overall sustainability maturity state; an indicator of an area specific maturity state; or an indicator of a severity of a condition affecting a sustainability index; on a virtual display.

In an embodiment, the sustainability dashboard unit 704 comprises computational circuitry configured to update a digital dashboard 717. In an embodiment, the sustainability dashboard unit 704 comprises computational circuitry configured to update a supplier sustainability index.

In an embodiment, the sustainability dashboard unit 704 comprises computational circuitry configured to determine one or more mitigation actions that improve a sustainability index. In an embodiment, the sustainability dashboard unit 704 comprises computational circuitry configured to determine one or more mitigation actions that improve a supplier sustainability index. In an embodiment, the sustainability dashboard unit 704 comprises computational circuitry configured to determine one or more mitigation actions that improve a compliance measure.

In an embodiment, the sustainability standard compliance system 700 includes a compliance unit 706 including computational circuitry configured to generate a compliance score based in part on a the predict sustainability index. In an embodiment, the compliance unit 706 comprises computational circuitry configured to initiate one or more push notices representing an enterprise-wide sustainability rating and a user specific sustainability rating responsive to receiving sustainability information from a plurality of remote devices, in an embodiment, the compliance unit 706 comprises computational circuitry configured to initiate one or more push notices representing an enterprise-wide carbon footprint rating and a user-specific carbon footprint rating responsive to receiving carbon footprint information from the plurality of remote devices.

In an embodiment, the compliance unit 706 comprises computational circuitry configured to initiate one or more push notices representing an enterprise-wide sustainability rating and a user-specific sustainability rating responsive to receiving sustainability information from a plurality of remote devices. In an embodiment, the compliance unit 706 comprises computational circuitry configured to initiate one or more push notices representing an enterprise-wide carbon footprint rating and a user-specific carbon footprint rating responsive to receiving carbon footprint information from the plurality of remote devices. In an embodiment, the compliance unit 706 comprises circuitry configured to initiate one or more push notices representing an enterprise-wide sustainability rating and a user-specific sustainability rating responsive to receiving sustainability information from a plurality of remote devices.

In an embodiment, the compliance unit 706 comprises circuitry configured to initiate one or more push notices representing an enterprise-wide carbon footprint rating and a user-specific carbon footprint rating responsive to receiving carbon footprint information from the plurality of remote devices. In an embodiment, the compliance unit 706 comprises circuitry configured to initiate one or more push notices including over or more user-selectable mitigation actions that improve a sustainability index, in an embodiment, the compliance unit 706 comprises circuitry configured to initiate one or more push notices including over or more user-selectable mitigation actions that improve a supplier sustainability index.

In an embodiment, the compliance unit 706 comprises circuitry configured to initiate one or more push notices including over or more user-selectable mitigation actions that improve a compliance measure. In an embodiment, the compliance unit 706 comprises computational circuitry configured to predict a compliance score. In an embodiment, the compliance unit 706 comprises computational circuitry configured to update a compliance score.

In an embodiment, the compliance unit 706 comprises computational circuitry configured to generate a compliance protocol, in an embodiment, the compliance unit 706 comprises computational circuitry configured to determine a certification rating. In an embodiment, the compliance unit 706 comprises computational circuitry configured to update a certification rating. In an embodiment, the compliance unit 706 comprises computational circuitry configured to generate a mitigation protocol.

In an embodiment, the compliance unit 706 comprises computational circuitry configured to establish a handshake and exchange with a remote certification server. In an embodiment, the compliance unit 706 comprises computational circuitry configured to generate a supplier sustainably priority rating and to present a priority modification menu including one or more instances of a priority level choice associated with a supplier.

In an embodiment, the compliance unit 706 comprises computational circuitry configured to modify a virtual sustainability queue arrangement of a plurality of users responsive to receiving one or more inputs indicative of a user sustainability index. In an embodiment, the compliance unit 706 comprises computational circuitry configured to classify a plurality of users as either high-priority or low priority based one a sustainability index. In an embodiment the compliance unit 706 comprises computational circuitry configured to modify a virtual priority arrangement of a plurality of users responsive to receiving the one or more inputs indicative of a modification to a sustainability index.

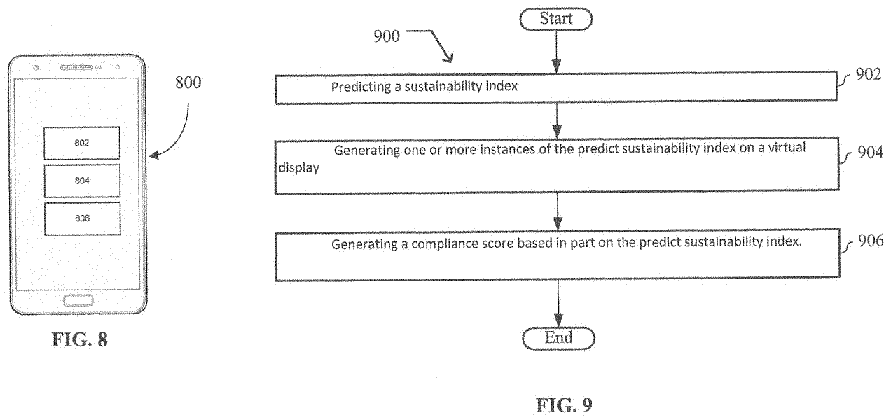

FIG. 8 shows a sustainability system 800 including means 802 for predict a sustainability index; means 804 for generating one or more instances of the predict sustainability index on a virtual display; and means 806 for generate a compliance score based in part on a the predict sustainability index.

FIG. 9 shows a method 900 for implementing one or more technologies and methodologies.

At 902 the method 900 includes predicting a sustainability index. In an embodiment, predicting the sustainability index includes predicting at least one indicator or measure of the quality of data used to predict the suitability index. In an embodiment, predicting the sustainability index includes predicting at least one indicator or measure of the source of data used to predict the suitability index.

In an embodiment, predicting the sustainability index includes predicting at least one indicator of a predicted sustainability maturity level. In an embodiment, predicting the sustainability index includes predicting at least one indicator of a predicted overall sustainability maturity level. In an embodiment, predicting the sustainability index includes predicting at least one indicator of a sustainability area specific maturity level.

In an embodiment, predicting the sustainability index includes predicting at least one indicator of a severity of a condition affecting a sustainability index. In an embodiment, predicting the sustainability index includes predicting at least one indicator of a social media reputation index.

In an embodiment, predicting the sustainability index includes predicting at least one indicator of a Scope 1 emissions event, Scope 2 emissions event, or Scope 3 emissions event. In an embodiment, predicting the sustainability index includes predicting a sustainability index based on one or more inputs indicative of a greenhouse gas emissions activity or a sustainability activity. In an embodiment, predicting the sustainability index includes predicting energy consumption information from one or more digital images associated with a utility meter output. In an embodiment, predicting the sustainability index includes predicting generating one or more instances of a predict a carbon footprint index on a virtual display.

At 904 the method 900 includes generating one or more instances of the predict sustainability index on a virtual display. In an embodiment, generating the one or more instances of the predict sustainability index on a virtual display includes generating one or more instances of a predict sustainability; an indicator or measure of the source of data used to predict the suitability index; an input data validity score; an indicator of a maturity state; an indicator of an overall sustainability maturity state; an indicator of an area specific maturity state; or an indicator of a severity of a condition affecting a sustainability index; on a virtual display. In an embodiment, generating the one or more instances of the predict sustainability index on a virtual display includes updating a supplier sustainability index.

At 906 the method 900 includes generating a compliance score based in part on the predict sustainability index. In an embodiment, generating the compliance score based in part on the predict sustainability index includes generating one or more mitigation actions that improve a sustainability index. In an embodiment, generating the compliance score based in part on the predict sustainability index includes generating one or more mitigation actions that improve a supplier sustainability index.

In an embodiment, generating the compliance score based in part on the predict sustainability index includes generating one or more mitigation actions that improve a compliance measure. In an embodiment, generating the compliance score based in part on the predict sustainability index includes generating a compliance score. In an embodiment, generating the compliance score based in part on the predict sustainability index includes updating a compliance score. In an embodiment, generating the compliance score based in part on the predict sustainability index includes generating a compliance protocol.

In an embodiment, generating the compliance score based in part on the predict sustainability index includes generating a certification rating. In an embodiment, generating the compliance score based in part on the predict sustainability index includes updating a certification rating.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include, but are not limited to, physically mateable, physically interacting components, wirelessly interactable, wirelessly interacting components, logically interacting, logically intractable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific integrated Circuits (ASICs), Field Programmable Gate Arrays (PDAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the type of signal-bearing medium used to carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link a wireless communication link (e.g., transmitter, receiver, transmission logic, reception logic, etc.), etc.).

While aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g, the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and S together, A and C together, B and C together, and/or A, B, and C together, etc.). Typically, a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), the various operations may be performed in orders other than those that are illustrated or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A sustainability and carbon footprint management system, comprising:
circuitry configured to acquire one or more of user-specific sustainability information, user-specific carbon footprint information, enterprise-wide sustainability information, or enterprise-wide carbon footprint information; and
circuitry configured to generate one or more of a user-specific sustainability status, a user-specific carbon footprint status, an enterprise-wide sustainability status, or an enterprise-wide carbon footprint status based on the acquired user-specific sustainability information, the user-specific carbon footprint information, the acquired enterprise sustainability information, or the enterprise carbon footprint information.

2. The sustainability and carbon footprint management system of claim 1, further comprising:
circuitry configured to display one or more instances of an aggregate environmental sustainability indicator, an aggregate economic sustainability indicator, or an aggregate social sustainability indicator based on an aggregate of the acquired user-specific sustainability information, the user-specific carbon footprint information, the acquired enterprise sustainability information, and the enterprise carbon footprint information.

3. The sustainability and carbon footprint management system of claim 1, further comprising:
circuitry configured to display one or more instances of a carbon footprint mitigation recommendation and a sustainability mitigation recommendation responsive to a comparison between the user-specific sustainability information, the user-specific carbon footprint information, the enterprise-wide sustainability information, or the enterprise-wide carbon footprint information; and a target user-specific sustainability, a target user-specific carbon footprint, a target enterprise-wide sustainability, or a target enterprise-wide carbon footprint.

4. The sustainability and carbon footprint management system of claim 3, wherein the circuitry configured to display one or more instances of a carbon footprint mitigation recommendation and a sustainability recommendation includes circuitry configured to display one or more instances of a user-specific carbon footprint mitigation recommendation and a user-specific sustainability recommendation responsive to a comparison between the user-specific sustainability information, the user-specific carbon footprint information, the enterprise-wide sustainability information, or the enterprise-wide carbon footprint information, and a target a target user-specific sustainability, a target user-specific carbon footprint, a target enterprise-wide sustainability, or a target enterprise-wide carbon footprint.

5. (canceled)

6. The sustainability and carbon footprint management system of claim 1, further comprising:
menu circuitry configured to generate a user interface presenting a sustainability mitigation menu and to receive one or more inputs indicative of a sustainability mitigation selection.

7.-9. (canceled)

10. The sustainability and carbon footprint management system of claim 1, further comprising:
menu circuitry configured to
generate a user interface presenting an enterprise-Sponsored sustainability mitigation menu and an enterprise-sponsored carbon footprint mitigation menu, and
receive one or more inputs indicative of at least one of an enterprise-sponsored sustainability mitigation selection or an enterprise-sponsored carbon footprint mitigation selection.

11.-14. (canceled)

15. The sustainability and carbon footprint management system of claim 1, further comprising:
circuitry configured to display one or more instances of a user-specific and enterprise-wide carbon footprint achievement level and user-specific and enterprise-wide sustainability achievement level responsive to a comparison between the user-specific sustainability information, the user-specific carbon footprint information, the enterprise-wide sustainability information, or the enterprise-wide carbon footprint information; and a target user-specific sustainability, a target user-specific carbon footprint, a target enterprise-wide sustainability, or a target enterprise-wide carbon footprint.

16.-25. (canceled)

26. A system, comprising:
a collective sustainability unit configured to acquire sustainability information from a plurality of remote devices and to generate user-specific sustainability information or user-specific carbon footprint information based in part on the acquired sustainability information or carbon footprint information; and
a collective carbon footprint unit configured to acquire carbon footprint information from the plurality of remote devices, and to generate enterprise-wide sustainability information or enterprise-wide carbon footprint information based in part on the acquired sustainability information or carbon footprint information.

27. (canceled)

28. The system of claim 26, further comprising:
a collective carbon footprint credit unit configured to manage user-specific carbon credits and enterprise-wide carbon credits associated with enterprise-wide acquired sustainability information or carbon footprint information.

29. The system of claim 28, further comprising:
a user interface presenting one or more instances of user-specific carbon credits or enterprise-wide carbon credits.

30. The system of claim 28, further comprising:
a carbon credit unit configured to facilitating payment to a digital wallet responsive to receiving one or more inputs indicative of transaction for to buy or sell user-specific carbon credits or enterprise-wide carbon credits.

31.-46. (canceled)

47. The system of claim 26, further comprising:
computational circuitry configured to display one or more instances of a predicted environmental sustainability measure, a predicted economic sustainability measure, or a predicted social sustainability measure responsive to acquiring the sustainability information or the carbon footprint information

48.-79. (canceled)

80. A sustainability standard compliance system, comprising:
a sustainability index unit including computational circuitry configured to predict a sustainability index;
a sustainability dashboard unit including computational circuitry configured to generate one or more instances of the predict sustainability index on a virtual display; and
a compliance unit including computational circuitry configured to generate a compliance score based in part on a the predict sustainability index.

81. The sustainability standard compliance system of claim 80, wherein the predicted sustainability index includes at least one indicator or measure of the quality of data used to predict the suitability index.

82.-90. (canceled)

91. The sustainability standard compliance system of claim 80, wherein the sustainability index unit includes computational circuitry configured to derive energy consumption information from one or more digital images associated with a utility bill or an invoice.

92.-108. (canceled)

109. The sustainability standard compliance system of claim 80, wherein the compliance unit includes computational circuitry configured to initiate one or more push notices representing an enterprise-wide sustainability rating and a user-specific sustainability rating responsive to receiving sustainability information from a plurality of remote devices.

110.-124. (canceled)

125. The sustainability standard compliance system of claim 80, wherein the compliance unit includes computational circuitry configured to generate a supplier sustainably priority rating and to present a priority modification menu including one or more instances of a priority level choice associated with a supplier.

126. The sustainability standard compliance system of claim 80, wherein the compliance unit includes computational circuitry configured to modify a virtual sustainability queue arrangement of a plurality of users responsive to receiving one or more inputs indicative of a user sustainability index.

127. (canceled)

128. (canceled)

129. The sustainability standard compliance system of claim 80, wherein the sustainability dashboard unit includes computational circuitry configured to generate one or more instances of the predict sustainability index on a virtual display.

130. (canceled)

131. The sustainability standard compliance system of claim 0, wherein the sustainability dashboard unit includes computational circuitry configured to generate one or more instances of
a predict sustainability;
an indicator or measure of the source of data used to predict the suitability index;
an input data validity score;
an indicator of a maturity state;
an indicator of an overall sustainability maturity state;
an indicator of an area specific maturity state; or
an indicator of a severity of a condition affecting a sustainability index;
on a virtual display.

132-158. (canceled)
